(19) United States
(12) Patent Application Publication
(10) Pub. No.: US 2015/0220983 A1
(43) Pub. Date: Aug. 6, 2015

(54) Systems and Methods of Determining Predictors Based on Transaction Data and Social Network Data

(71) Applicant: MASTERCARD INTERNATIONAL INCORPORATED, Purchase, NY (US)

(72) Inventor: Rohit Chauhan, Somers, NY (US)

(73) Assignee: MASTERCARD INTERNATIONAL INCORPORATED, Purchase, NY (US)

(21) Appl. No.: 14/173,621

(22) Filed: Feb. 5, 2014

(51) Int. Cl. G06Q 30/02; G06Q 50/00

(52) U.S. Cl. CPC G06Q 30/0255; G06Q 50/01

(57) ABSTRACT

Disclosed are exemplary embodiments of systems and methods for processing data associated with a purchasing entity. In an exemplary embodiment, a method generally includes accessing transaction data including a plurality of payment card events, each of the plurality of payment card events occurring within a time interval and being associated with the purchasing entity. The method further includes accessing social network data based on a parameter of the purchasing entity, linking the transaction data and the social network data based on the purchasing entity, determining a predictor based on both the transaction data and the social network data, the predictor indicative of a possible future transaction by the purchasing entity and transmitting, to at least one of the purchasing entity and a merchant, the predictor and/or an offer associated with the predictor.

### FIELD

The present disclosure relates to systems and methods for processing transaction data and social network data, and more particularly, to determining predictors of a future transaction based, at least in part, on the transaction data and the social network data.

### BACKGROUND

This section provides background information related to the present disclosure which is not necessarily prior art.

Known payment card transactions are used to purchase a variety of different goods and services. Because the payment card transactions are directed to and approved by a card issuer, data related to the transactions using the card is accessible to the card issuer. The card issuer is generally known to use this information to market particular goods or merchant partners to the card holder, either directly or through a merchant partner. Separately, persons are known to participate in social networks as a way to interact with friends, relatives, and others.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in processing data associated with a purchasing entity and determining predictors based on the data.

FIG. 2 is a block diagram of a computing device, that may be used in the exemplary system of HG.

FIG. 3 is an exemplary method for processing data associated with a purchasing entity and determining predictors based on the data.

Corresponding reference numerals indicate corresponding parts throughout the several views of the drawings.

### DETAILED DESCRIPTION

Example embodiments will now be described more fully with reference to the accompanying drawings.

While historical transaction data for a purchasing entity, such as an individual consumer, may generally be useful in predicting future transactions, augmenting the transaction data with social network data associated with the purchasing entity focuses the ability of the data to predict future transactions for the purchasing entity within a time interval. In the described embodiments, systems and methods determine one or more predictors of possible future transactions, by the purchasing entity, based on both the transaction data and the social network data of the purchasing entity.

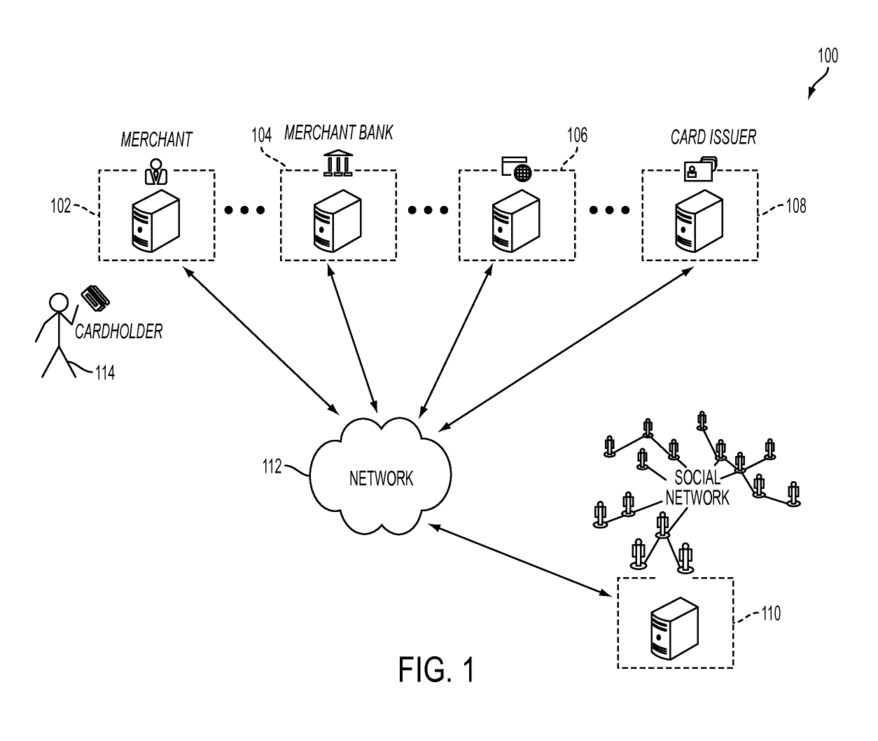

FIG. 1 illustrates an exemplary system 100, in which the one or more aspects of the present disclosure may be implemented. Although, in the described embodiment, components of the system 100 are presented in one arrangement, other embodiments may include the same or different components arranged otherwise, depending, for example, on authorization processes for payment card transaction systems and/or types of social networks used.

Referring to FIG. 1, the system 100 generally includes a merchant 102, a merchant bank 104, a payment service 106, an issuer (and/or issuer bank) 108, and asocial network 110, each coupled to network 112. The network 112 may include, without limitation, a local area network (LAN), a wide area network (WAN) (e.g., the Internet, etc.), a mobile network, a virtual network, and/or another suitable public and/or private network capable of supporting communication among two or more of the components illustrated in FIG. 1, or even combinations thereof. For example, network 112 may include multiple different networks, such as a private card transaction network made accessible by the payment service 106 and the Internet, by which the social network 110 may be accessed.

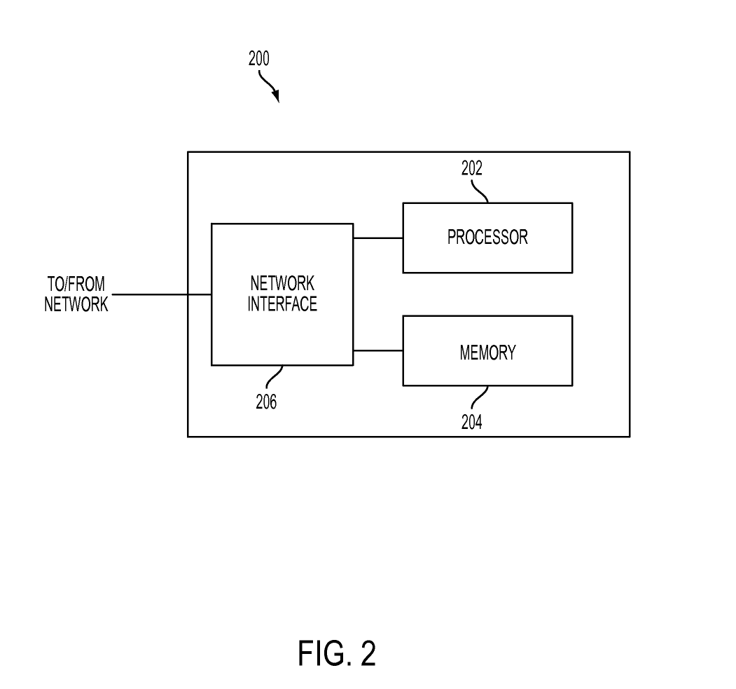

Each of the merchant 102, the merchant bank 104, the payment service 106, the issuer 108, and the social network 110 in the illustrated system 100 may be implemented in any one or more computing devices, such as a computing device or multiple computing devices located together, or distributed across a geographic region. For illustration, the system 100 is further described below with reference to an exemplary computing device 200 illustrated in FIG. 2. The system 100, and the components therein, however, should not be considered to be limited to the computing device 200, as different computing devices and/or arrangements of computing devices may be used in other embodiments.

The exemplary computing device 200 includes a processor 202 and a memory 204 coupled to the processor 202. The processor 202 may include, without limitation, a central processing unit (CPU), a microprocessor, a microcontroller, a programmable gate array, an ASIC, a logic device, or the like. The memory 204 is a computer readable media, which includes, without limitation, random access memory (RAM), a solid state disk, a hard disk, compact disc read only memory (CD-ROM), erasable programmable read only memory (EPROM), tape, flash drive, and/or any other type of volatile or nonvolatile physical or tangible computer-readable media. Memory 204 may be configured to store, without limitation, transaction data, social network data, purchasing entity information, and/or other types of data suitable for use as described herein.

The computing device 200 further includes a network interface 206 coupled to the processor 202. The network interface 206 may include, without limitation, a wired network adapter, a wireless network adapter, a mobile telecommunications adapter, or other device capable of communicating to one or more different networks, including the network 112. In at least one embodiment, computing device 200 includes processor 202 and one or more network interfaces 206 incorporated into or with processor 202.

Referring again to FIG. 1, the merchant 102, the merchant bank 104, the payment service 106, and the issuer 108 cooperate, in response to a purchasing entity (e.g., a purchase by the purchasing entity 114), to complete a payment card transaction. Purchasing entity 114 may include, for example, a purchaser, a group of purchasers (e.g., a household, etc.), an institutional purchaser, a professional group, a business, or any other entity that purchases products, including, e.g., goods or services, etc. In the exemplary embodiment, the purchasing entity 114 initiates the transaction by presenting a payment card, such as a credit card, a debit card, a pre-paid card, etc. to the merchant 102.

As an example, in a credit card transaction in the system 100, the merchant 102 reads the payment card and communicates the account number and an amount of the purchase to the merchant bank 104 to determine whether the card is in good standing and whether there is sufficient credit to complete the transaction. The merchant bank 104, in turn, communicates with the issuer 108, through a payment service 106, such as, for example, a credit card payment system using the MasterCard® interchange, for authorization to complete the transaction. If the issuer 108 accepts the transaction, an authorization is provided back to the merchant 102 and the merchant 102 completes the transaction. The credit line of the purchasing entity 114 is then decreased by the amount of the purchase, and the charge is posted to the account associated with the credit card. The transaction is later settled by and between the merchant 102, the merchant bank 104, and the issuer 108.

While the above transaction is described with reference to a credit card, payment card transactions may further include other card transaction, such as debit card transactions and pre-paid card transactions, as suggested above. For debit cards and pre-paid cards, a transaction is substantially similar to the above, but may further include the use of a personal identification number (PIN) authorization and more rapid posting of the charge to the account associated with the card, etc.

Regardless of the type of card transaction, transaction data may be generated, collected, and stored as part of the above interactions among the merchant 102, the merchant bank 104, the payment service 106, the issuer 108, and the purchasing entity 114. The transaction data includes a plurality of payment card purchase events, i.e., transactions using one or more payment cards. In several embodiments, for each purchase event, transaction data, including, for example, an account number of the payment card, a price of the transaction, and a date/time of transaction, is transmitted from the merchant 102 to the issuer 108. Transaction data may also include payment card events associated with multiple different payment card accounts, such as two different MasterCard® accounts. Additionally, transaction data may include a product or merchant category, such as, for example, travelodge, books, hobby, veterinary, services, electronics, household appliances, or any other grouping of like or similar products (e.g., by merchant category code (MCC)). Transaction data may further include other product specific information, such as model numbers, brands, ticket or price per product, etc. This additional transaction data may also be collected, transmitted and/or stored by the merchant 102, merchant bank 104, payment service 106, and/or issuer 108. It should be appreciated that still other transaction data related to transactions, products, and/or purchasing entities may further be collected and/or stored within the system 100.

Transaction data may be stored in different components of the system 100. In various embodiments, the payment service 106, for example, collects and stores the transaction data in memory 204. The same or different transaction data may be stored within other components of the system 100. For example, the merchant 102 may collect transaction data that also includes merchant data, which is not communicated to the issuer 108 in a request thr authorization. Such merchant data may include, without limitation, details of the products purchased, and may further include data for transactions completed using a form of payment other than payment card. While this merchant data may be unnecessary for authorization to complete a payment card transaction, it may be used otherwise, as described below, for example, as part of processing transaction data. Accordingly, in various embodiments, the payment service 106, issuer 108, or other components of the system 100, or other entities, may collect this merchant data as additional transaction data, and/or store it in the memory 204 associated therewith.

In some embodiments, transaction data includes identified transaction data and/or un-identified transaction data. Identified transaction data is transaction data directly related to one or more purchasing entities based on, for example, the identity of the purchasing entity, or an account number or other unique identifier associated directly with a purchasing entity (e.g., “User 101”). Un-identified transaction data is transaction data where the identity of the purchasing entity is omitted, yet still indirectly related to the purchasing entity by one or more demographics. The demographics may include, for example, age, gender, geographic region (e.g., ZIP code), interests, lifestyle activities, etc. In this manner, the transaction data may be sufficiently anonymous to, for example, preserve the privacy of the purchasing entity, yet sufficiently specific to the purchasing entity to be useful in the systems and methods herein. Transaction data may include identified transaction data, un-identified transaction data, or both identified and un-identified transaction data in some embodiments. Furthermore, in numerous embodiments, identified transaction data may further include one or more demographics associated with the related one or more purchasing entities.

Referring again to FIG. 1, social network 110 may include, for example, Twitter®, Facebook®, LinkedIn®, Google+®, YouTube®, Instagram®, Pinterest®, blogs, combinations thereof, etc. The social network 110 may include any system, in which, for example, a purchasing entity posts social content to one or more forums and/or reviews social content posted by others to one or more forums. The forums may include a social network profile of a purchasing entity, for example, or a posting forum, in which persons post and/or review content by username. In the exemplary embodiments, the social network 110 includes social network data, which may include all or any portion of the content on the social network 110, or within a social network profile associated with the social network 110. Social network data may include, for example, a purchasing entity's comments about impending purchases in a product category, a preferred brand of hotel, rental car agency, a preferred television show, an interesting dog breed, airline, or the purchasing entity's experience at a social function the prior day. More generally, it can be seen that social network data may include content relating to future purchases of a purchasing entity, and also content generally unrelated to future purchases by the purchasing entity, etc.

Like transaction data, and as described in more detail below, social network data may include, in some embodiments, identified social network data and/or un-identified social network data. The social network data is generally stored in the memory 204 of the social network 110. In some embodiments, the social network data may be stored in one or more other components of the system 100, or within another computing device associated with one or more purchasing entities 114, yet still accessible to the system 100, or components thereof.

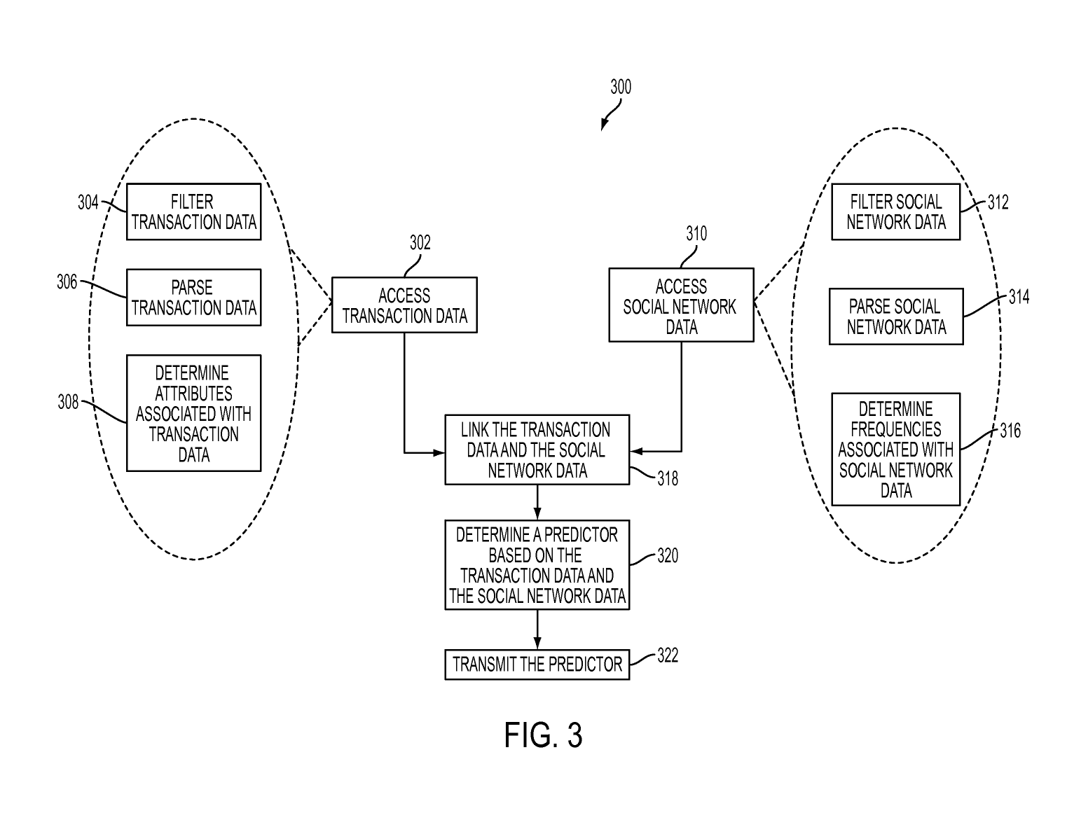

FIG. 3 illustrates an exemplary method 300 of processing data associated with a purchasing entity. The exemplary method 300 may be implemented in any one or more of the merchant 102, the merchant bank 104, the payment service 106, the issuer 108, and the social network 110 of the system 100, each of which is one or more computing device, as described above. For purposes of illustration, therefore, the exemplary method 300 is described herein with reference to computing device 200. It should be appreciated that the methods described herein are not limited to the system 100, or computing device 200. And, conversely, the systems and computing devices described herein are not limited to the exemplary method 300.

Referring to FIG. 3, as part of the exemplary method 300, the processor 202 accesses (e.g., retrieves, receives, etc.) the transaction data at 302, for example, from the merchant 102, the payment service 106, the issuer 108, etc. The transaction data includes a plurality of payment card events (e.g., periodic, non-periodic, or a combination thereof), which may be stored locally, remotely, or some combination thereof. In this embodiment, for example, a part of the transaction data is stored in memory 204 at the payment service 106, while the remaining transaction data (e.g., merchant data, etc.) is stored at the merchant 102. As should be apparent to those skilled in the art, a variety of operations may be employed to access 302 the transaction data depending, for example, on where the transaction data is stored, the type/volume of transaction data being accessed, whether the transaction data is identified or un-identified, etc. In addition, transaction data may be accessed via additional or different sources, for example, the merchant bank 104, the issuer 108, or other sources, etc.

As part of accessing the transaction data at 302, the processor 202 may optionally (indicated by the dotted lines) filter the transaction data according to one or more criteria at 304. In one example, the processor 202 filters transaction data based on the identity of the purchasing entity 114, e.g., John Smith, where the transaction data is identified transaction data related only to the purchasing entity 114. In another example, the processor 202 filters the transaction data based on one or more demographics related to the purchasing entity 114, such as age, gender, purchase category, or geographic region associated with the purchasing entity or merchant involved in a transaction (e.g., ZIP code, street address, county, province, etc). Transaction data may be filtered, in this manner, where the transaction data is un-identitied transaction data. In several embodiments, transaction data for multiple un-identified purchasing entities may be filtered based on one or more criteria, including without limitation, age gender, geographic region, interests, lifestyle markers, or purchase category, etc., and combined with the purchasing data for an identified purchasing entity 114 based on the criteria.

In additional examples, identified and/or un-identified transaction data may be further filtered based on a time interval, such as one month, two months, six months, a year, or a different, longer, or shorter, time interval. The time interval may permit all available data to be included. Alternatively, the predetermined time interval may be narrowed to reduce the occurrence of irrelevant or dated transaction data. For example, transaction data, such as gas station purchases, may be omitted after two, three or nine months, where the time interval provides sufficient more recent data to identify a routine. In another embodiment, all available data (e.g., two, four or more years) may be used to identify a routine vacation occurring semi-annually.

Additionally, or alternatively, as shown in FIG. 3, filtered or un-filtered transaction data may be parsed at 306 based on one or more multiple criteria. In this exemplary embodiment, as shown in Table 1, the transaction data is parsed according to the identity of the purchasing entity 114 (or “User 101”) and by merchant category. The processor 202 creates a data structure for the purchasing entity 114, where at least a portion of the transactions data for an account of the purchasing entity 114 is populated into the data model and organized longitudinally.

The processor 202 may further determine a number of spending attributes (e.g., growth of grocery spend month-over-month, spend at hotels in the past 3 months divided by total spend in hotels in the past 12 months, etc.) for the account at 308. The determined attribute(s) are cyclical and/or cross-category at the merchant category level (e.g., groceries, airlines, gas, hotel, apparel, etc.) over different time frames. The time frames may be the same or different in various embodiments, and may vary in duration, such as in days, weeks, months, etc. In this example, the predetermined time intervals are defined by three months and then six months. In this example, the processor 202 determines, based on time-series, longitudinal raw and summarized transaction data statistical methods (e.g., ARIMA, Logit Regression, Neural Networks, etc.), probabilities of individual future purchases (in one or more time frames) for a merchant category including the ticket size of the transaction ($). As shown in Table 1, for example, the probability of a future airline category purchase in the next 6-12 months is 0.20 for a ticket size of $1,200. It should be appreciated that, in other examples, a variety of different statistical methods may be employed to calculate a variety of different attributes from transaction data associated with one or more purchasing entities 114.

TABLE 1

| | | 0-3 months | | 3-6 months | | 6-12 months | |
|---|---|---|---|---|---|---|---|
| | Industry | Proba- | | Proba- | | Proba- | |
| | Code | bility | Amount | bility | Amount | bility | Amount |
| User | Grocer- | 0.7 | $450 | 0.94 | $500 | 0.50 | $1,000 |
| 101 | ies | | | | | | |
| | Airlines | 0.60 | $900 | — | — | 0.20 | $1,200 |
| | Gas | 0.97 | $300 | 0.95 | $350 | 0.85 | $900 |
| | Hotel | 0.59 | $450 | — | — | 0.15 | $500 |

Referring again to FIG. 3, in addition to accessing the transaction data at 302, the processor 202 accesses social network data at 310. The social network data is stored at the social network 110, or elsewhere in system 100. In this exemplary embodiment, the processor 202 accesses the social network 110 based on a parameter of the purchasing entity 114. The parameter may include, for example, the identity of the purchasing entity, or a demographic associated with the purchasing entity. Where the parameter is the identity of the purchasing entity, the accessed social network data is directly related to the purchasing entity 114, i.e., identified social network data. It may be that, for example, the purchasing entity 114 has provided permission to the payment service 106 to directly access the social network 110. In this manner, the processor 202 accesses the social network profile of the purchasing entity 114, with the purchasing entity's permission, and retrieves all or a portion of the social network data contained in or linked to the profile.

Additionally, or alternatively, in accessing the social network data at 306, the processor 202 may receive/retrieve social network data from the social network. 110, based on one or more parameters, other than the identity of the purchasing entity 114 (or other unique identifier thereof), i.e., as un-identified social network data. In such examples, the social network 110 omits the identity of the person who posted and/or reviewed the data, but includes one or more demographic(s) associated with the responsible person. When social network data is received in this manner, the processor 202, in accessing the social network data, filters the un-identified social network data at 312 based on one or more of the demographics (e.g., age, gender, geographic location, interests, lifestyle markers, trends in the social network data or profile, etc.) about the purchasing entity 114. As such, this social network data, while potentially not specific to the purchasing entity 114, is filtered based on a demographic of the purchasing entity 114, and is therefore more related to the purchasing entity 114 than the unfiltered, un-identified social network data retrieved from the social network 110. It should be appreciated that as additional demographics associated with the purchasing entity 114 are included in the filtering operation at 308, the more specific the data becomes to the purchasing entity 114. Alternatively, in at least one embodiment, identified social network data may be included with the un-identified social network data, based on, for example, age, gender, geographic location, interests, lifestyle markers, trends in the social network data or profile, or any other criteria included in the social network data and common to one or more purchasing entities 114, etc.

In the exemplary embodiment, the processor 202 may further parse the identified and/or un-identified social network data, i.e., the free text social data, at 314 based on keyword searching and/or sentiment analysis. In this particular example, the social network data is populated into a fixed format data structure at the account level, as shown in Table 2. The data structure may include a variety of different categories and/or columns to extract as much, or as little, social network data as relevant to a particular category, or topic. As shown in Table 2, for example, the columns include location, brand, store/outlet, etc. Any number of different data structures, for other purposes, may be compiled to provide insight into a variety of different predictors. For example, to predict a future possible purchase in the veterinarian service category, the data structure shown in Table 2 would not be used. Instead, a data structure, based on keyword searching and/or sentiment analysis, may include, for example, breed, illness type, pet food brands, location, or other information related to veterinarian services, etc.

In the example depicted in Table 2, the processor 202 (using a parsing algorithm) searches for one or more keywords, such as, for example, vacation, holiday, time-off, the names of cities or location of interest, brands associated with travel, airlines, etc. The processor 202 populates the data structure from the social network data, which may result in one or more fields of the data structure being empty or not available (“N/A”), as shown below. Again, the data structure may include more, less, or different fields in an effort to better predict a future possible purchase. The data structure, however, is preferably constructed to aid in the determining a predictor, but not inhibit efficient processing of the social network data by inclusion of unrelated, marginally relevant, or often missing data. In addition to parsing the social network data, the processor 202 may further determine one or more frequencies at which one or more categories are mentioned at 316, as indicated in Table 2. Simply, in this example, the higher number of times the city or location (e.g. Hawaii) is mentioned in the social media data in a particular time frame, the higher the frequency or interest in that location. Further, ticket size of the transaction ($) may also be determined by searching in the social network data for dollar amount, or assigning values based on other social network data.

TABLE 2

| | Industry | 0-3 months | | | | | |
|---|---|---|---|---|---|---|---|
| | Code | Frequency | Timing | Location | Brand | Store/Outlet | Ticket |
| User | Airlines | 9 | 0-30 days | Hawaii | Sample | Sampleairline.com | N/A |
| 101 | | | | | Airway | | |
| | Hotel | 7 | 0-30 days | Hawaii | Sample | N/A | $600 |
| | | | | | Hotel | | |
| | Clothing | 2 | 31-60 days | Elm Paso | Sample | Mall | $45 |
| | | | | | Clothing | | |

With continued reference to FIG. 3, after accessing the transaction data at 302 and accessing the social network data at 306, the processor 202 links the transaction data and the social network data at 310 based on the purchasing entity 114. In one example, the transaction data and the social network data may be linked at 318 based on the identity of the purchasing entity 114. Preferably, the identity of the purchasing entity 114 may be used in linking the data when the purchasing entity 114 provides access to the social network data, as described above. Alternatively, in various examples, where either the social network data or the transaction data is un-identified, the transaction data and the social network data may be linked at 310 based on a geographic region of the purchasing entity 114. In other examples, the transaction data and the social network data may be linked at 310 based on other demographics associated with the purchasing entity 114, such as age, gender, marital status, etc.

After the data is linked at 318, the processor determines one or more predictors at 320, based on the linked data. The predictors are indicative of a possible future transaction by the purchasing entity 114, based on both the transaction data and the social network data. In this manner, because the predictor is based on multiple types of data about the purchasing entity 114, the likelihood of the predictor accurately predicting a future transaction within a time interval is increased, over other methods that rely only on one type of data, e.g., transactional data. The predictor may include, without limitation, a product, a brand, and a product category, and also a price indicative of the size of the transaction and a temporal indicator, including a time interval in which the future transaction is likely to take place, etc.

While the predictor may be determined in a variety of different manners, in this exemplary embodiment, the processor 202 determines the predictor at 320 by time series algorithms that leverage both longitudinal trends in transaction data and longitudinal trends in the social network data in order to determine possible future purchases. As shown in Table 3, for example, the transaction data, as depicted in Table 1, and the social network data, as depicted in Table 2, are linked based on the identity of the purchasing entity, User 101. Then, the processor 202, based on time series transaction data for the purchasing entity 114, in this example, determines at 320 that the purchasing entity 114 is likely to take a vacation in the coming 30 days by combining probabilities indicated by the transaction data and probabilities indicated by the social network data to triangulate the predictor. Each of the transaction data and the social network data separately provided insight, but it is only by combining the two data types that a more accurate probability is determined. In particular, the transaction data only indicates a probability of 0.59 for a hotel purchase in the next 3 months, while the social network data indicated a probability of medium-high for a hotel purchase in the next 3 months. By combining the probabilities/frequencies, according to one or more time series algorithms, the processor 202 determined a predictor of a possible future hotel purchase to be high or >0.9.

TABLE 3

| | | Probability | Timing | Location | Brand | Store | Ticket |
|---|---|---|---|---|---|---|---|
| User | Hotel | High (>0.9) | 0-30 days | Hawaii | Sample | HotelBrand.com | $450-500 |
| 101 | | | | | Hotel | | |

Further, the predictor, in this example, includes a ticket size for the possible future purchase. This is calculated, in this example, by leveraging regression and machine learning methodologies, based on the transaction data as well as social network data. It should be appreciated that different keywords, number of keywords, different methodologies, and different time frames/intervals may be used, by the processor 202, to determine any number of different possible future transactions, whether for travel, appliance, automobile, insurance, school supplies, or any other product or service susceptible to prediction based on transaction data and social network data.

In another illustrated example, a purchasing entity 114, such as John Smith, takes a vacation in April each year. John Smith historically pays for travel arrangements with a credit card, and thus the transaction data associated with John Smith reflects this pattern of the travel. Specifically, for example, as part of the vacation John Smith purchases airline tickets, hotel rooms, meals at restaurants outside a particular distance from his residence, car rental, etc. In the weeks or months prior to the next April vacation, John Smith may begin to solicit advice about particular vacation locations, or a purchase associated with the travel, from his friends and family through one or more social networks. For example, John Smith may post questions to his Facebook® profile about a particular airline, fees for checking bags, or flights to a particular location, or restaurants/hotels in the particular location. Thus, while the transaction data alone is useful in predicting that a future purchase may occur, by the addition of the social network data, the processor 202, using a time series algorithm, is then able to determine the specifics of the purchase, for example, the location of John Smith's April vacation, the particular airlines John Smith is considering, etc., thereby improving, in this example, the timing, accuracy, and specificity of the predictor.

The predictor includes a temporal indicator, and is thus limited in time, based on the type of transaction included in the purchase and keywords in the social network data. In particular, social network data often includes temporal keywords, such as months, dates, seasons, spring break, or other words related to travel, purchases, or other temporal indicators, etc., which may be searches by the processor to determine if the predictor is associated with a particular time for the possible future transaction. For instance, referring to Table 3, the temporal indicator is 0-30 days. The granularity of the temporal indicator, in this example, is based on the transaction data, to indicate timing more broadly, e.g., next three months, and further based on the social network data, to indicate timing more accurately, such as by reference in the data to certain travel date (e.g., “the week of May 15”). Also, referring to the John Smith vacation example, keyword searching may be used in social network data related to the vacation to determine whether the vacation will occur in “March,” “April,” or “May.”

Because the predictor is based on both transaction data and social network data, the method may be able to predict, not only the time interval of the future transaction, but also the product category, the ticket size of the transaction (or product), the brand of the possible future purchase, and the store from which the possible purchase is to be made. In particular, social network data often includes keywords that may be searched, by the processor 202, to identify this information. For example, referring to the Table 3 above, keywords related to brands of hotels, vendors of hotel products/services, dollar signs or symbols, and location may be employed to provide further detail to the predictor.

Additionally, in several embodiments, by using both transaction data and social network data, the certain social network data may be ignored, where the social network data does not correspond to transaction data. For example, a car enthusiast might often post about a model of car, or particular car maker. However, such social network data is often not indicative or informative of a possible future transaction, for example, the purchase of a new or used car. In this example, the processor 202 does not determine a predictor, based on this social network data, because no corresponding transaction data exists.

Once determined, the processor 202 stores the one or more predictors in memory, such as, for example, memory 204. Additionally, the processor 202 transmits the predictor, or a part thereof, at 322 to another computing device, in the system 100 or separate from the system 100. In numerous embodiments, where the method is implemented by the payment service 106, the processor 202 may transmit predictors to one or more merchants 102, who offer products (i.e., goods and services) associated with the predictor, and, in some embodiments, to merchants 102 whose service area includes a residence of the purchasing entity or entities 114. For example, if a predictor indicated that John Smith expects to purchase an airline ticket, the payment service 106 may transmit the predictor to merchants 102 who offer airline tickets, for flights out of an airport proximate to John Smith's residence. In turn, the merchant may, for example, send one or more offers (e.g., coupons, discounted rates, advertisements, etc.) to John Smith for the product(s) indicated or associated with the predictor. In at least one embodiment, the processor 202 transmits the predictor to a merchant 102 who offers products, not indicated in the predictor, but related to the products indicated in the predictor. For example, where the predictor indicates John Smith is taking a ski vacation in Vail, Colo. in April, the predictor may be transmitted, by the processor 202, to a ski shop merchant located proximate to John Smith's residence, such that the merchant 102 would be able to send coupons or other offers for ski equipment and/or apparel to John Smith.

Additionally, or alternatively, in some embodiments, the processor 202 directly transmits an offer for a product indicated by the predictor to the purchasing entity 114. Further, where the predictor is determined for multiple different purchasing entities 114, the processor 202 may transmit the same or different offers, each for a product indicated by the predictor, to each of the purchasing entities 114.

It should be appreciated that the functions described herein, in some embodiments, may be described in computer executable instructions stored on a computer readable media, and executable by one or more processors. The computer readable media is a non-transitory computer readable media. By way of example, and not limitation, such computer-readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) accessing transaction data including a plurality of payment card events, the plurality of payment card events occurring within a time interval and associated with a purchasing entity, (b) accessing social network data based on at least one parameter of the purchasing entity, (c) linking, by a processor, the transaction data and the social network data based on the purchasing entity, (d) determining, by the processor, a predictor based on both the transaction data and the social network data, the predictor indicative of a possible future transaction by the purchasing entity, and (e) transmitting, to at least one of the purchasing entity and a merchant, the predictor and/or an offer associated with the predictor.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-based method for processing data associated with a purchasing entity, the method comprising:
accessing transaction data including a plurality of payment card events, each of the plurality of payment card events occurring within a time interval and being associated with the purchasing entity;
accessing social network data based on a parameter of the purchasing entity;
linking, by a processor, the transaction data and the social network data based on the purchasing entity;
determining, by the processor, a predictor based on both the transaction data and the social network data, the predictor indicative of a possible future transaction by the purchasing entity; and
transmitting, to at least one of the purchasing entity and a merchant, the predictor and/or an offer associated with the predictor.

2. The method of claim 1, wherein the parameter includes an identity of the at least one purchasing entity.

3. The method of claim 2, wherein accessing the social network data includes accessing, by a network interface, a social network profile associated with the purchasing entity based on the identity of the purchasing entity and retrieving the social network data from the social network profile.

4. The method of claim 2, wherein accessing the social network date includes parsing the social network data based on the identity of the purchasing entity and at least one category.

5. The method of claim 1, wherein the parameter includes a demographic of the purchasing entity, and wherein accessing the social network data includes filtering the social network data from un-identified social network data based on the demographic.

6. The method of claim 1, wherein the plurality of payment card events includes periodic payment card events, and wherein the social network data includes content related to the periodic payment card events; and
wherein determining the predictor includes identifying at least one of a product category, associated with the possible future purchase, based on the social network data.

7. The method of claim 1, wherein the transaction data includes merchant data received from at least one merchant, the merchant data including information pertaining to a product in one of the payment card events.

8. The method of claim 1, wherein the plurality of payment card events includes multiple payment card events associated with a first payment card account and multiple payment card events associated with a second payment card account.

9. The method of claim 1, wherein the predictor includes at least two of an identity of the purchasing entity, a product category, a size of transaction, and a temporal indicator.

10. The method of claim 1, wherein the parameter includes a geographic region associated of the purchasing entity, and wherein accessing the social network data includes filtering the social network data from un-identified social network data based on the geographic region.

11. A system for managing data associated with at least one purchasing entity, the system comprising:
a memory configured to store transaction data including a plurality of payment card events associated with the at least one purchasing entity; and
a processor coupled to the memory and configured to:
retrieve social network data from a social network, based on at least one parameter associated with the at least one purchasing entity;
link the transaction data and the social network data based on the at least one purchasing entity;
determine a predictor of a transaction of the at least one purchasing entity, within a predetermined future time interval, based on both the transaction data and the social network data, the predictor indicative of a product category; and
transmit the predictor to a merchant at least partially based on the product category.

12. The system of claim 11, wherein the processor is configured to access, and store in the memory merchant data associated with the at least one purchasing entity, the transaction data including the merchant data.

13. The system of claim 11, wherein the processor is configured to retrieve un-identified social network data from the social network and filter non-identified social network data, based on at least one demographic of the at least one purchasing entity, when retrieving said social network data.

14. The system of claim 11, wherein the at least one parameter includes at least one of an identity of the at least on purchasing entity and a demographic associated with the at least one purchasing entity.

15. The system of claim 14, wherein the predictor includes at least two of an identity of the purchasing entity, a product category, a size of transaction, and a temporal indicator.

16. The system of claim 11, wherein the processor is configured to transmit the predictor to the merchant, based on a service area of the merchant including a residence of the at least one purchasing entity.

17. The system of claim 11, wherein the processor is further configured to parse the social network data into one or more data structures based on at least one keyword search associated with a product category, and wherein the processor is configured to link the transaction data with the parsed social network data based on the at least one purchasing entity.

18. A non-transitory computer readable media comprising instructions executable that, when executed by at least one processor, cause the at least one processor to:
access transaction data including a plurality of payment card events, the plurality of payment card events occurring within a time interval and being associated with a purchasing entity;
access un-identified social network data based on at least one demographic of the purchasing entity;
link the transaction data and the social network data based on the purchasing entity; and
determine a predictor based on both the transaction data and the social network data, the predictor indicative of a possible transaction by the purchasing entity within a time interval.

19. The non-transitory computer readable media of claim 18, wherein the instructions executable that, when executed by the at least one processor, cause the at least one processor to:
link the transaction data and the social network data based on an identity of the purchasing entity.
